(19) United States
(12) Patent Application Publication
(10) Pub. No.: US 2025/0236927 A1
(43) Pub. Date: Jul. 24, 2025

(54) METAL-DISSOLVING APPARATUS, PROCESSES, AND USES THEREOF

(71) Applicant: HATCH LTD., Mississauga (CA)

(72) Inventors: Tom PLIKAS, Mississauga (CA); Amreen KHERA, Mississauga (CA); Majid MALEKI, Mississauga (CA); Dylan VAN DEN BERG, Mississauga (CA); Robert John FRASER, Mississauga (CA)

(21) Appl. No.: 18/998,998

(22) PCT Filed: Jul. 27, 2023
(86) PCT No.: PCT/CA2023/051015

§ 371 Date: Jan. 27, 2025

Related U.S. Application Data
(63) Continuation-in-part of application No. 17/979,350, filed on Nov. 2, 2022.
(60) Provisional application No. 63/392,641, filed on Jul. 27, 2022.

(51) Int. Cl. C22B 3/02; C22B 3/04; C22B 3/46; C22B 15/00

(52) U.S. Cl. CPC C22B 3/02; C22B 3/04; C22B 3/46; C22B 15/0065; C22B 15/0091

(57) ABSTRACT

A metal-dissolving apparatus and process is disclosed. The apparatus comprises a reactor, a metal inlet for receiving a metal-containing substance, a solution inlet for receiving a metal-dissolving solution, a solution outlet for providing the metal-dissolving solution comprising dissolved metals. The apparatus comprises a length and a height, the height being less than the length. The process comprises providing a metal-dissolving solution into a first location of a reactor comprising metal-containing substances, flowing the metal-dissolving solution through the reactor, dissolving metal from the metal-containing substances into the metal-dissolving solution, and discharging the metal-dissolving solution from the reactor.

### FIELD

The present disclosure relates generally to apparatuses for dissolving or leaching metal from metal-containing substances. The dissolved or leached metal may be useful for production of consumer, industrial, or agricultural products.

### BACKGROUND

Metal-dissolving equipment is used for dissolution or leaching of metal from metal-containing substances. Once dissolved or leached, the metal may be further processed and/or isolated for use in the production of different chemicals, or materials such as for batteries, electroplating, animal feeds, fertilizers, toothpaste, agricultural sprays, etc.

Conventional metal dissolution processes are either batch or continuous.

For a conventional batch process, conventional metal-dissolving equipment comprises an agitated batch tank. The tank is filled with metal and a dissolving solution, and left to sit for a period of time (which may include periodic or continuous stirring). Once the metal has been sufficiently dissolved, the contents of the tank are all removed.

In a stirred tank system, however, the large particles do not stir well and become unevenly distributed relative to the dissolving solution, with a tendency for the large particles to sink towards the bottom of the tank due to weight.

In a conventional continuous process, a dissolver column is filled with the metal-containing substance. The dissolving solution is provided into the column at a certain location, flowed past the metal-containing materials within the column to dissolve the metals in the solution that is passing by, then removed from the column at another location. The solution being removed from the column contains the dissolved metals. The solution may be processed to extract the dissolved metals, then re-circulated back into the column in a continuous-loop process.

To maximize the amount of metal that is dissolved, it is desirable for the reactor to contain a packed bed of metal components. A challenge with dissolving metals using dissolving solution in a process comprising a packed bed of metal components (also referred to as a packed bed process), irrespective of whether it is a batch or a continuous process, is ensuring mixing and even distribution across the column of the chemical components of the metal-dissolving solution. The typical design practice for dissolving columns to help achieve this uniformity of mixing and distribution for all chemicals of the solution, both horizontally and vertically within a column, is to size the column diameter to be approximately 10 times the largest metal-containing particle size, and then to size the column height to be approximately 4 to 8 times the diameter of the column. Accordingly, the height-to-diameter ratio of a conventional column is typically between four-to-one and eight-to-one, where a ratio is calculated by dividing the height by the diameter. The column diameter (width) is constant throughout. This practice is generally known and relied upon in the field of art to help try to achieve a sufficient uniformity of mixing and distributions of all the chemicals of the solution across the column (both horizontally and vertically). Without such uniformity of mixing and distribution of the solution, there may be areas of the column where the solution is at lower concentration of reactants, and/or largely unreacted metal dissolution solution may pass out of the column. This can result in a reduced or otherwise hindered ability to dissolve metal to a desired amount or target. The slender column helps, in part, prevent the solution from back-flowing in the column.

To be effective and efficient at dissolving or leaching metal-containing substances, dissolver columns also need to be of a sufficient height to allow for a sufficiently high flow rate, and also a sufficiently high target residence time, of the solution in the column. For example, a column may need to be at least 6 to 8 meters in height. Such heights are required for metal-dissolving kinetics: the solution must be flowed by the metal-containing materials at a threshold rate/velocity to encourage dissolution of the metal; and the solution must reside in the column a threshold amount of time to remain in contact with the metal-containing substances so as to dissolve a sufficient amount of metal before the solution exits the column (otherwise the full dissolution capacity of the solution is not utilized).

For these reasons, conventional columns must be tall to allow for the solution to be flowed within the column at an optimal rate for an optimal residence time, while still maintaining the correct height-to-diameter ratio to ensure uniformity of mixing and distribution of all the chemical of the solution across the column.

In certain process conditions, however, the optimal height to help achieve uniform mixing and distribution may be different than the optimal height to achieve the minimum solution velocity and residence time. Furthermore, although there is an incentive to use taller columns to increase the amount of metal-containing substances that can be processed at one time, if the column is too tall, the solution reagent concentrations can drop to lower levels in upper portions of a column making the dissolution reaction slower, and therefore not effectively utilizing the entire volume of metal containing substances in the column for dissolution.

Because of the foregoing design requirements, columns are typically symmetrical and of a continuous diameter (with sometimes a conical section at the bottom), and they are assembled onsite with supports external to the reactor itself to prevent the tall, slender, columns from falling over.

A solution which resolves the challenges and trade-offs of using columns to dissolve or leach metal from metal-containing substances is desired.

### BRIEF DESCRIPTION OF THE FIGURES

Embodiments of the present disclosure will now be described, by way of example only, with reference to the attached Figures.

FIG. 1 depicts a front perspective view of a metal-dissolving apparatus as described herein.

FIG. 2 depicts a back perspective view of the metal-dissolving apparatus of FIG. 1, further depicting a delivery system for providing a leach solution a metal-containing substance into the apparatus.

FIG. 3A depicts a front perspective internal view of a metal-dissolving apparatus in an embodiment of the present disclosure.

FIG. 3B depicts a front view and a side view of the perforated pipe shown in FIG. 3A according to an embodiment of the present disclosure.

FIG. 3C depicts a front perspective view of a portion of a metal-dissolving apparatus in an embodiment of the present disclosure, the apparatus comprising a reactant distribution device having a false bottom with penetrating nozzles.

FIG. 4 depicts a metal-dissolving apparatus with dividers defining separate reactors according to an embodiment of the present disclosure.

FIG. 5A-D depicts a schematic view of a batch metal-dissolving system operated in a particular sequence according to an embodiment of the present disclosure, the system comprising a metal-dissolving apparatus, a recirculation tank, and a buffer tank.

FIG. 6A-E depicts a schematic view of another batch metal-dissolving system operated in a particular sequence according to an embodiment of the present disclosure, the system comprising a metal-dissolving apparatus, a first recirculation tank, and a second recirculation tank.

### DETAILED DESCRIPTION

Described herein is a metal-dissolving system, apparatus, and process.

The metal-dissolving apparatus has a height that is less than its length. The metal-dissolving apparatus may be a box. The apparatus may comprise a reactant distribution device 170 to help hydraulically force uniformity of flow of chemical components of the dissolving solution. The distribution device may be, for example, perforated pipes, penetrating nozzles, or a false bottom.

The term height as used herein refers to the vertical dimension of the apparatus. The term length as used herein refers to the longest, non-diagonal, horizontal dimension of the apparatus. The term width as used herein refers to the shortest horizontal dimension of the apparatus.

The apparatus may have a height that is less than that of equivalent capacity dissolver columns (e.g., less than about 6 to 8 meters). The apparatus may have a height-to-length ratio of less than one (1), where a ratio is calculated by dividing the height by the length. In an embodiment, the metal-dissolving apparatus is a box.

The height, length, and width of the apparatus may be proportional to one another such that the apparatus is self-supporting. For example, to be self-supporting, the apparatus may have a height-to-length ratio of 1 or less. This means the apparatus will not overturn even if the apparatus base is tilted up to 45 degrees from horizontal even when the apparatus is in use (containing metal-containing materials and dissolving solution). In an embodiment, the self-supporting apparatus must be able to safely remain standing when in use without any structural supports outside of the space defined by the apparatus. In an embodiment, the self-supporting apparatus is configured to have a center of mass that is of a height that is less than half of the width of the apparatus. The term self-supporting does not preclude the apparatus from being anchored to a foundation or supporting structure to help prevent horizontal/lateral movement and/or for added safety.

The apparatus may comprise a sufficiently flat, large base. The height and base of the apparatus may be dimensioned so that the apparatus can be installed on flat surfaces, such as a structural foundation, without requiring peripheral infrastructure to install, secure, support, and/or stabilize apparatus, such as elevated structural elements, external supports, etc. The apparatus may also be configured to fit within a standard shipping container. Generally, shipping containers have dimensions of about 4 meters in height, by 5 meters in width, by 12 meters in length. As such, the apparatus may be sized and shaped to be transportable within the envelope of a standard shipping container. For example, the apparatus may be substantially rectangular in shape, and may be 4 m height×4 m width×11 m length. The reactor 110 may be rectangular in plan view.

The metal-dissolving apparatus may be a reactor. The reactor may have a simple, modular substantially rectangular design. Generally, a modular structure refers to a structure that may be largely manufactured and/or assembled off-site from its intended destination; may be readily transportable to its intended site; may require relatively less installation, finishing work, and/or assembly on-site; and/or may be readily assembled once on-site. A modular reactor may be configured to have a shape that integrates or interlocks with an inverse shape of an identical modular reactor. The reactor may comprise eight corners. Such substantially rectangular designs may allow for maximizing the dissolution-processing volume obtainable from a dimensional size that can be efficiently shop-fabricated and readily shipped through standard transportation means. The metal-dissolving apparatus may provide a reactor having a substantially box-shaped configuration. Apparatuses having such configurations may have a height low enough to facilitate maintaining uniform leaching process conditions within the apparatus reactor.

The metal-dissolving apparatus may comprise one or more dividers, where the divider(s) divide the apparatus into a plurality of reactors. Each of the plurality of reactors may define a separate dissolving section or zone of the apparatus. The reactor may be divided or segmented width-wise and/or length-wise. The reactor may comprise a plurality of dividers. By forming these separate dissolving sections or zones with dividers, the metal-dissolving apparatus may be configured to separately dissolve or leach different metal-containing substances, and may be able to separately collect loaded metal-dissolving solutions.

Alternatively, the metal-dissolving apparatus may be comprised of a plurality of reactors. Each of the plurality of reactors may be a modular reactor that is physically separate and not connected to any of the other modular reactors. In such an embodiment, an individual reactor may not necessarily be self-supporting or have a height-to-length ratio of less than one, but the apparatus as a whole may comprise multiple reactors arranged adjacent to one-another in such a way that the entire apparatus itself, when taken is a whole, is self-supporting or have a height-to-length ratio of less than 1. In an embodiment, each reactor may be a separate module which can be individually transported and/or affixed to other reactors. In another embodiment, the reactors may be placed and arranged within a container, the apparatus comprising the combination of the container and the arranged reactors therewithin.

Apparatuses as described herein may include a reactant distribution device 170 for helping hydraulically force a uniform flow of metal-dissolving solution throughout the apparatus. The reactant distribution devices 170 may help avoid needing to rely on back pressure created by packed beds of metal-containing substance (which is used in conventional dissolver columns) to provide uniformity of flow (for example, columns having a height-to-diameter ratio of between about four-to-one and eight-to-one, where a ratio is calculated by dividing the height by the diameter). Apparatuses according to the present disclosure may have a low enough height that, when coupled with the distribution device to help hydraulically force uniformity of reactant flow, they can maintain spatially uniform process conditions on a scale that is of commercial size-relevance, such as achieving scale-up. Maintaining uniformity of conditions at scale can be important, as the leaching processes described herein may be stable within a narrow operating envelope of acidity, pH, peroxide to acid ratio, temperature, metal strength (otherwise referred to as metal concentration in solution), etc. Reactant distribution devices 170 that may enable such uniformity of conditions may comprise perforated pipes, penetrating nozzles, false bottoms that may be perforated or coupled to penetrating nozzles, a series of metal-dissolving solution inlets, or a combination thereof. The reactant distribution device 170 may be located within the body of the reactor which also contains the leaching solution.

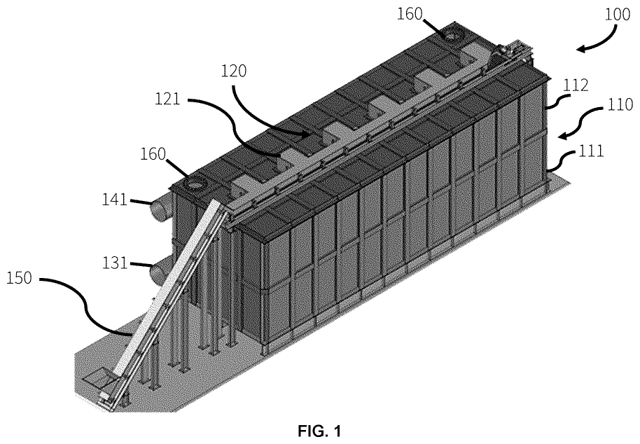

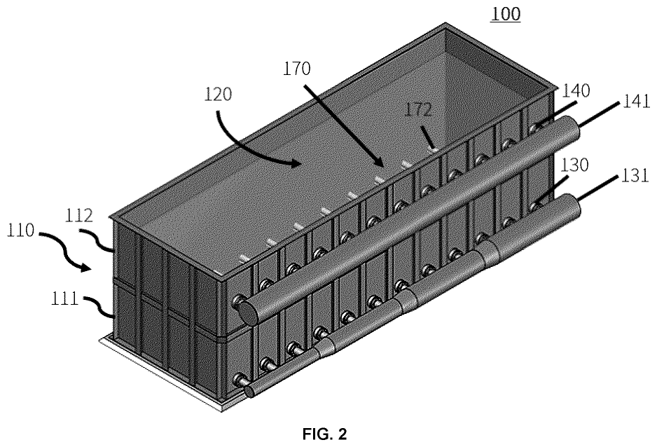

FIGS. 1 and 2 depict a metal-dissolving apparatus 100 according to embodiments of the present disclosure. In the embodiments depicted in FIGS. 1 and 2, the metal-dissolving apparatus 100 comprises a reactor 110. Although reference is made to the reactor 110 with respect to structural features, their locations and their operations, those features, locations, and operations may be similarly applied to the apparatus in approximately the same ways identified for the reactor 110.

Referring to FIGS. 1 and 2, the metal-dissolving apparatus 100 comprises a reactor 110. The reactor 110 has a length and height, with the height being less than the length. The reactor 110 may be self-supporting. The reactor 110 comprises a metal inlet 120 positioned at a first location on the reactor 110 for providing into the reactor 110 a metal-containing substance (not shown in FIG. 1). The metal inlet 120 may be positioned along the height of the reactor 110, optionally within an upper portion 112 of the reactor 110. As depicted in FIG. 2, the metal inlet 120 may be an opening in the upper portion 112 of the reactor 110. The reactor 110 also comprises a solution inlet 130 positioned at a second location on the reactor 110 for providing a metal-dissolving solution into the reactor 110, and a solution outlet 140 at a third location on the reactor 110 for discharging the metal-dissolving solution from the reactor 110.

Further, the reactor 110 may comprise a ventilation system (e.g., see ventilation air outlet 160, shown in FIG. 1) positioned at a fourth location on the reactor 110. The ventilation system may comprise at least one gas inlet and at least one gas outlet configured and positioned for providing gas flow into the reactor 110 and displacement of gases out of the reactor 110. For example, the ventilation system may include ventilation air ingress through an opening in 120 or through entry ports 121 or dedicated air ingress opening(s) around the roof (not shown), and may include a ventilation air outlet 160, optionally two or more outlets 160, positioned along the height and length of the reactor, optionally within an upper portion 112 of the reactor 110.

The ventilation system may be an off-gassing system. The ventilation system may further comprise a gas-capturing system. Gases such as hydrogen, oxygen, or a combination thereof may be released during dissolution or leaching of the metal-containing substance. Gases may be released due to corrosion of the metal-containing substance with acid (e.g., may release hydrogen). Gases may be released from reactions involving oxidants such as peroxide (e.g., may release oxygen). Resulting gases may carry aerosols of liquid in the reactor 110, and may need to be cleaned in a gas-cleaning device (e.g., such as a scrubber or mist eliminator). Generation of hydrogen often needs to be diluted before being released into the atmosphere, recovered, or captured for use in order to maintain concentrations below hydrogen's lower explosive limit. Alternatively, air may need to be kept out to enable hydrogen to be recovered and/or captured for use.

The reactor 110 may comprise a delivery system such as the delivery system 150 shown in FIG. 1. The delivery system 150 is coupled to the reactor 110 for providing the metal-containing substance to the metal inlet 120. The delivery system 150, as depicted, comprises a conveyor that delivers metal-containing substance into the reactor 110 via entry ports 121. The delivery system 150 may additionally or alternatively comprise a robotic system that delivers the metal-containing substances to the reactor 110 via entry ports 121. The robotic system may be mounted along the length's edge of the reactor 110. Alternatively, the metal-containing substance may be delivered loosely, in bags or drums, or on pallets, such that the drums may be tipped, bags may be broken, and loose substances may be deposited into the entry ports.

The reactor 110 that has a height that is less than the length of the reactor. With respect to the reactor 110, the term height as used herein refers to the vertical dimension of the reactor. The term length as used herein refers to the longest, non-diagonal, horizontal dimension of the reactor. The term width as used herein refers to the shortest horizontal dimension of the reactor. The reactor 110 may have a height that is less than that of dissolver columns (e.g., less than about 6 to 8 meters). The reactor 110 may be have a height to length ratio of less than one (1), where a ratio is calculated by dividing the height by the length.

The height, length, and weight of the reactor may be proportional to one another such that the reactor 110 is self-supporting. For example, to be self-supporting, the reactor 110 may have a length-to-height ratio of 1 or larger. This means the reactor 110 will not overturn even if the reactor 110 base is tilted up to 45 degrees from horizontal even when the reactor 110 is in use (containing metal-containing materials and dissolving solution). In an embodiment, the self-supporting reactor 110 must be able to safely remain standing when in use without any structural supports outside of the space defined by the reactor. In an embodiment, the self-supporting reactor is configured to have a center of mass that is of a height that is less than half of the width of the reactor. Despite being self-supporting, the reactor 110 may nonetheless be certainly anchored to a foundation or supporting structure to help prevent horizontal/lateral movement and for safety. The reactor 100 may comprise a sufficiently flat, large base. The height and base of the reactor 110 may be dimensioned so that the reactor 110 can be installed on flat surfaces, such as a structural foundation, without requiring peripheral infrastructure to install, secure, support, and/or stabilize the reactor 110, such as elevated structural elements, external supports, etc. The reactor 110 may also be configured to fit within a standard shipping container. Generally, shipping containers have dimensions of about 4 meters in height, by 5 meters in width, by 12 meters in length. As such, the reactor 110 may be sized and shaped to be transportable within the envelope of a standard shipping container. For example, the reactor 110 may be substantially rectangular in shape, and may be 4 m height×4 m width×11 m length. The reactor 110 may be rectangular in plan view.

In an embodiment, the reactor 110 is modular (not shown in FIGS. 1 and 2). A modular reactor 110 may be configured so as to be assembled with other modular reactors 110 that are similar or substantially identical in shape and size. The metal-dissolving apparatus 100 may comprise a plurality of modular reactors 110. In such an embodiment, an individual reactor 110 may not necessarily be self-supporting, or have a height-to-length ratio of less than one. However, the apparatus 100 may comprise multiple reactors arranged adjacent to one-another in such a way that the apparatus 100 itself, when taken is a whole, is self-supporting or has a height-to-length ratio of less than 1. Each reactor may be a separate module which can be individually transported and/or affixed to other reactors 110. The reactors 110 may be affixed to one another using fasteners such as nuts and bolts. In another embodiment, the reactors 110 may be placed and arranged within a container, the apparatus 100 comprising the combination of the container and the arranged reactors therewithin.

A reactor of the present disclosure may be formed out of metal, cement, plastic, or a combination thereof. The reactor may be formed out of fibre reinforced plastic (FRP), high density polyethylene (HDPE), crosslinked HDPE, polyvinyl chloride (PVC), chlorinated PVC (CPVC), polypropylene (PP), etc. The reactor may be formed out of metal or concrete, and, lined with FRP, rubber, or other plastics.

The reactor 110 comprises a solution inlet 130, and a solution outlet 140. The solution inlet 130 and outlet 140 may each comprise a plurality of openings within the outside walls of the reactor 110. The solution inlet 130 may be at a second location along the height and length of the reactor 110, optionally extending along the length of the reactor including with openings that are positioned along the length of the reactor a certain distance apart; or along the height and width of the reactor 110, optionally extending along the width with the openings positioned a certain distance apart. The solution outlet 140 may be at a third location along the height and length of the reactor, optionally extending along the length of the reactor; or along the height and width of the reactor, optionally extending along the width.

As depicted in FIGS. 1 and 2, the solution inlet 130 may extend along the length of the reactor 110 within a lower or bottom portion 111 of the reactor. The solution outlet 140 may also extend along the length of the reactor 110, within an upper or top portion 112 of the reactor. So positioned, the inlet 130 and outlet 140 may provide a flow of metal-dissolving solution going into the lower portion of the reactor, flowing upward through to the reactor and past the metal-containing materials within the reactor, and reaching an upper portion of the reactor. The solution may then exit the reactor through the outlet 140. The flow of the solution may be countercurrent to the flow of the metal-containing substance, where the solution can flow into the reactor 110 at a lower location, and flow upwards through any metal-containing substance moving down with gravity as metal substance in a lower portion within the reactor 110 dissolves and shrinks, and then the pregnant leach solution may be discharged from the upper portion of the reactor.

Alternatively, the solution inlet 130 may extend along the length of the reactor 110 within an upper or top portion 112 of the reactor, and the solution outlet 140 may extend along the length of the reactor within a lower or bottom portion 111. So positioned, the inlet 130 and the outlet 140 may provide for a flow of metal-dissolving solution going from the upper portion of the reactor downward through to the lower portion of the reactor. The flow of the solution may be co-current to the flow of the metal-containing substance, where the solution can flow into the reactor 110 at the upper portion, and flow downwards through any metal-containing substance also moving down with gravity as substance in a lower portion within the reactor 110 dissolves and shrinks, and then the solution may be discharged from the lower portion of the reactor. Optionally, the solution inlet 130 and the solution outlet 140 may be positioned along opposing widths, or ends of the reactor 110, where each may be respectively positioned in the upper 112 or lower 111 portions of the reactor. So positioned, the inlet 130 and outlet 140 may help provide for a flow of metal-dissolving solution that is cross-current to the flow of the metal-containing substance, where the solution can flow into the reactor 110 from one end, and flow across any metal-containing substance moving down with gravity as substance in a lower portion within the reactor 110 dissolves and shrinks, and then the solution may be discharged from the other side.

The solution inlet 130 may comprise a series of openings that extend along an outside length of the reactor 110. The solution inlet 130 openings may receive the solution from a manifold 131. The manifold 131 may taper as it extends along the length of the reactor 110. The taper may help provide even flow of the solution to each of the openings of the inlet 130. The manifold 131 may have individual conduits which connect the manifold 131 to each of the openings of the solution inlet 130.

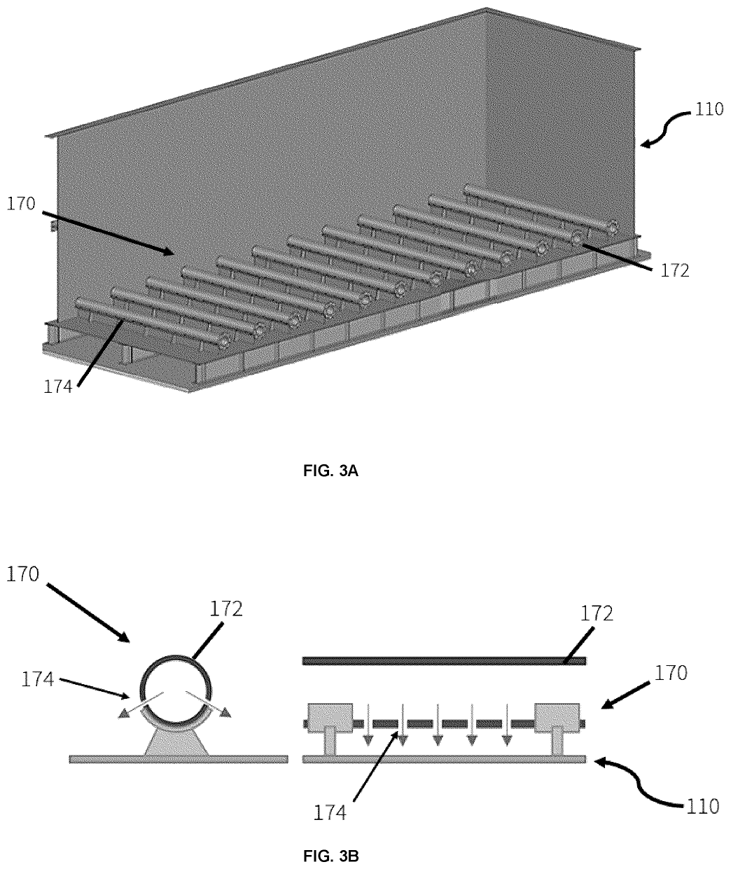

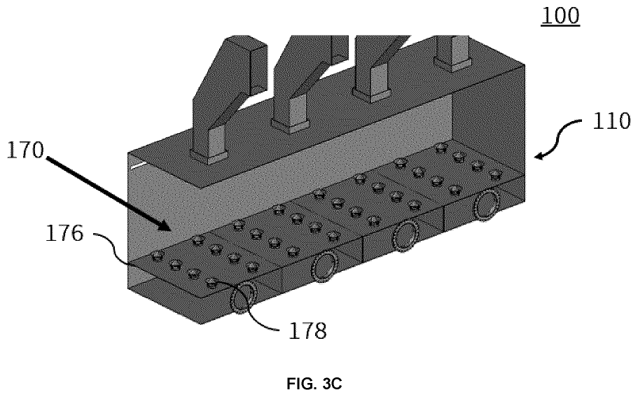

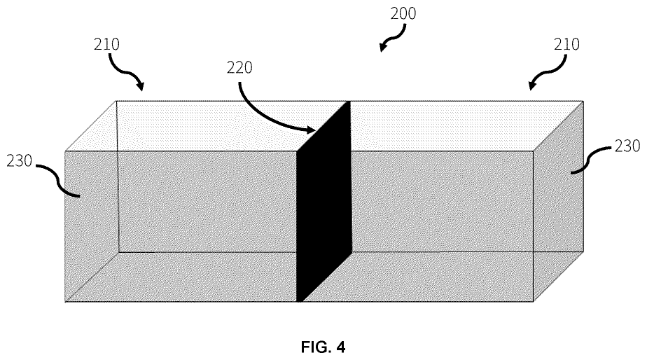

FIG. 3A shows a front perspective internal view of the interior of the reactor 110 of FIGS. 1 and 2. The reactor 110 comprises a plurality of pipes 172 with holes or perforations 174 therein (shown in FIG. 3B), located within the reactor 110 as the device 170 for helping hydraulically enable uniformity of flow of reactants through the reactor 110. The pipes 172 are connected to the solution inlet 130 (shown in FIG. 2) to receive the metal-dissolving solution and provide the solution into the reactor 110. Each pipe may be connected to an opening of the solution inlet 130. The perforated pipes 172 may assist with the more even distribution and/or flow of the solution across the vertical and/or horizontal aspects of the reactor 110. The perforations 174 may be only located in a certain area of the pipes to help control the distribution and/or rate of flow of the solution within the reactor 110. For example, the perforations 174 may only be located along the bottom portion of the pipes 172, including as shown in FIG. 3B. Locating the perforations 174 along the bottom portion of the pipes 172 can assist with causing the solution to first descend into the reactor 110 (see the arrows in FIG. 3B), then flow upward within the reactor around the pipes. The pipes 172 may extend across an inside width of the reactor 110. The pipe 172 may be configured to help distribute the metal-leaching solution with substantially spatial uniformity throughout the reactor by, for example, impeding the flow of the solution thereby forcing the solution to disperse when it passes upward and goes around the metal pipes 172. The pipes 172 may be removable. Use of removable pipes may allow for producing or designing pipes as consumables (thinner gage and less expensive material can be used for shorter life span). It may also result in less welding effort, as the pipes would not be secured to the reactor 110 such that it cannot be removed or moved. For example, less expensive material could be used to produce pipes having a shorter life span and/or reduced upfront costs. Use of removable pipes may also facilitate maintenance and inspection of the pipes 172 or reactor 110 including the bottom of the reactor below the pipes. Additionally, the solution outlet 140 may comprise a series of outlets that extend along an outside length of the reactor 110, supported and fed by a manifold 141 for discharging the metal-leaching solution.

FIG. 3C depicts a front perspective view of a portion of a metal-dissolving apparatus 100 in an embodiment of the present disclosure. The apparatus 100 comprises a reactor 110 a reactant distribution device 170. The distribution device 170 has a false bottom 176 with penetrating nozzles 178. The chemical reactant enters the cavity defined by the false bottom 176. The reactant then emerges from the cavity into the main part of the reactor containing the metal through the penetrating nozzles 178. The reactant may enter the cavity defined by the false bottom 176 via pipes (not shown). The distribution of the penetrating nozzles 178 across the false bottom 176 may help better or more uniformly distribute the flow of reactant across the width and length of the reactor 110.

FIG. 4 depicts a metal-dissolving apparatus 200 according to embodiments of the present disclosure. In the embodiments depicted in FIG. 4, the metal-dissolving apparatus 200 comprises a reactor 210. Although reference is made to the reactor 210 with respect to structural features, their locations and their operations, those features, locations, and operations may be similarly applied to the apparatus in approximately the same ways identified for the reactor 210.

Referring to FIG. 4, the metal-dissolving apparatus 200 is divided by a divider 220. The divider 220 divides the apparatus into a plurality of reactors 210. Each of the plurality of reactors 210 defines a separate dissolving section or zone 230 of the apparatus 200. The reactor 210 may be divided or segmented width-wise (as depicted in FIG. 4) and/or length-wise (not shown). The reactor 210 may comprise a plurality of dividers (not shown). By forming these separate dissolving sections or zones 230 with dividers 220, the metal-dissolving apparatus 200 may be configured to separately dissolve or leach different metal-containing substances, and/or may be able to separately collect loaded metal-dissolving solutions. Where the apparatus 200 comprises a plurality of reactors, the reactors 210 may operate in parallel or series, or a combination of both. Where the reactors are arranged/operated in series, the leach solution may sequentially pass from one reactor to the next. This can help minimize the excess reagent in the final discharged solution from the last reactor in the series. In an embodiment, the reactors 210 may be connected by conduits to allow the metal-dissolving solution to pass between the reactors.

The metal-dissolving apparatus described herein may be used to implement a metal-dissolving process. That process may comprise one or more of the following steps. A metal-containing substance may be introduced into a metal-dissolving apparatus as described herein, via a metal inlet. A metal-dissolving solution may be provided with substantially spatial uniformity into a lower portion of the apparatus when the apparatus contains the metal-containing substance. The solution may be provided into the apparatus through a plurality of perforated pipes to more evenly distributed the solution across the apparatus. The metal-dissolving solution may be flowed through the apparatus under a relatively low hydrostatic load, while maintaining substantially uniform metal-dissolving conditions across the length and height of the apparatus. The size and shape of the apparatus, wherein the apparatus has a height that is less than its length, may result in the relatively low hydrostatic load, and may allow the metal-dissolving conditions to be maintained substantially uniformly across the length and height of the apparatus, due to lower vertical gradients. The metal-dissolving conditions may comprise pH, leaching-reagent ratios, temperature, dissolved metal concentration, or a combination thereof, and are maintained within a desired range for dissolving metal.

The process as described herein may be a batch process. The term “batch” is generally understood by persons skilled in the present field of art of the present application to refer to a process that does not have a steady state of (also referred to as stable) process conditions. As used herein, a “batch” process refers to one where one or more process conditions are changing over time, such process conditions including any one or more of (i) ratios of metal-dissolving solution to metal-containing substance, (ii) concentrations of reagents in the metal-dissolving solution, (iii) temperatures, pressures, pH, or flow rates, (iv) concentrations of dissolved metal within metal-dissolving solution, and (v) concentrations of metal ions within the leach solution re-circulating to the reactor.

The process as described herein may be a continuous process. The term “continuous” is generally understood by persons skilled in the present field of art of the present application to refer to a process that achieves or is intended to achieve a relatively steady state (such that it has stable process conditions) over the entire period of operation. For a metal dissolving process to be continuous, the following process conditions must all eventually achieve stability (i) amounts and concentrations of reagents in the metal-dissolving solution being introduced into a metal-dissolving apparatus, (ii) minimum or larger amounts and/or surface area of metal containing substances to be dissolved within the apparatus, (iii) amounts and concentrations of metal ions within the leach solution re-circulating to the reactor; and (iv) amounts and concentrations of loaded metal-dissolving solution exiting the apparatus. Each process condition must remain stable generally, or relative to each of the other process conditions. It is recognized that despite there being fluctuations in process conditions, they are still considered steady state or stable when within experimental error/operational tolerances. Such fluctuations do not detract from the leaching process being continuous.

The metal of the metal-containing substance may be dissolved or leached into the metal-dissolving solution. So loaded with dissolved or leached metal, the metal-dissolving solution may then be discharged from an upper portion of the apparatus. The metal-dissolving solution may be re-circulated or recycled back into the apparatus. The apparatus may comprise a pump to help circulate, and optionally help re-circulate, the metal-dissolving solution in the apparatus.

The metal-containing substance (also referred to as feedstock) described herein may comprise relatively pure metals that dissolve readily; impure metals; metal alloys; full or cut cathodes or cathode sheets; metal pellets, rounds, or crowns; metal shot, scrap, or shredded metal; metal powder or briquettes; or a combination thereof. The metals may include nickel, cobalt, nickel/cobalt alloys, ferronickel, manganese, copper, or a combination thereof. The apparatus and process described herein may receive a quite pure metal feedstock as the metal-containing substance. The apparatus and process described herein may be configured to receive other types of feedstock as the metal-containing substance(s), including electrowon or hydrogen reduced or carbonyl process produced pure metals, less pure metals produced pyrometallurgically or by other means, mixtures of different metals, metal alloys such as ferronickel or as may be derived from spent catalyst treatment, or other metallic feedstocks.

The metal-dissolving solution described herein may comprise an acid in aqueous solution. The metal-dissolving solution described herein may comprise an acid and an oxidant in aqueous solution. The acid may be sulfuric acid, hydrochloric acid, nitric acid, or a combination thereof. The oxidant may be added as a solid, liquid, or gas. The oxidant may be SO₂/oxygen; peroxide; oxygen; oxidants that have cations comprising or consisting of H+ or the metal being dissolved, oxidants that have an anion comprising or consisting of sulfate, or a combination thereof; or a combination thereof. Oxidants that comprise cations consisting of H+ or the metal being dissolved, and comprise anions consisting of sulfate may be selected when producing metal-comprising battery chemicals. The metal-dissolving solution described herein may comprise sulfuric acid with or without an oxidant in aqueous solution. The metal-dissolving solution may comprise an aqueous solution of sulfuric acid and peroxide.

The metal dissolved or leached from the metal-containing substance may be used in production of consumer products (e.g., batteries, toothpastes), industrial products or processes (e.g., batteries, electroplating), or agricultural products (e.g., feeds, fertilizers, sprays, etc.). Metal sulfates may form from the metal dissolved or leached from the metal-containing substance. The metal sulfates may include nickel sulfate, zinc sulfate, cobalt sulfate, manganese sulfate, copper sulfate, or a combination thereof. So formed, the metal sulfates may be further processed and/or recovered via processes occurring downstream of the metal-dissolving apparatus, and may be used in production of batteries (e.g., nickel sulfate); used in electroplating (e.g., nickel sulfate); used in animal feeds, fertilizers, toothpaste, or agricultural sprays (e.g., zinc sulfate); or as mineral processing flotation reagents (copper sulfate) or a combination thereof.

Any one or more of the metal-dissolving apparatus, processes, and uses of the present disclosure may provide any one or more of the following.

The metal-dissolving apparatus may provide a reactor having a simple, modular substantially rectangular design. The modular reactor may be configured to have a shape that integrates or interlocks with an inverse shape of an identical modular reactor. The reactor may comprise eight corners. Such substantially rectangular designs may allow for maximizing the dissolution-processing volume obtainable from a dimensional size that can be efficiently shop-fabricated and readily shipped through standard transportation means. The metal-dissolving apparatus may provide a reactor having a substantially box-shaped configuration. Reactors having such configurations may have a low enough height that, coupled with a distributed series of metal-dissolving solution inlets or other device for helping hydraulically force a uniformity of metal-dissolving solution flow, may provide an ability to maintain spatially uniform process conditions on a scale that is of commercial size-relevance, such as achieving scale-up. As mentioned above, maintaining uniformity of conditions at scale can be important, as the processes described herein may be stable within a narrow operating envelope of acidity, pH, peroxide to acid ratio, temperature, metal strength (otherwise referred to as metal concentration in solution), etc.

As a result of the size and shape of the reactor, the metal-dissolving apparatus may require less interconnecting piping, feed systems, instrumentation, valving, etc. Further, the metal-dissolving apparatus may result in a high metal-dissolution capacity throughput module/per unit cost (e.g., up to 40,000 t/a metal eq., depending on feedstock type).

The low height of the reactor relative to its length may result in the metal-dissolving apparatus requiring less complicated material feeding systems (e.g., the solution inlet), lower building heights (e.g., less than 6 meters), lower pressure drop/pumping power, lower hydro/geostatic loads (from the pressure of the metal-containing substances and solution when the reactor is in use), lower elevation conveyors for loading metal or a combination thereof. Further, the metal-dissolving apparatus may achieve more uniform process conditions due to lower vertical gradients, may be easier to operate and/or maintain, may be easier and/or faster to install, may be able to handle a broad range of variable feedstocks & sizes of metal-containing substances (pellets, cathodes, rounds, crowns, etc.), or a combination thereof.

Described herein are metal-dissolving systems, and processes for dissolving metals. The systems comprise metal-dissolving apparatus according to embodiments of the present disclosure. The systems may further comprise additional structures, such as recirculation tanks, buffer tanks, holding tanks, or a combination thereof.

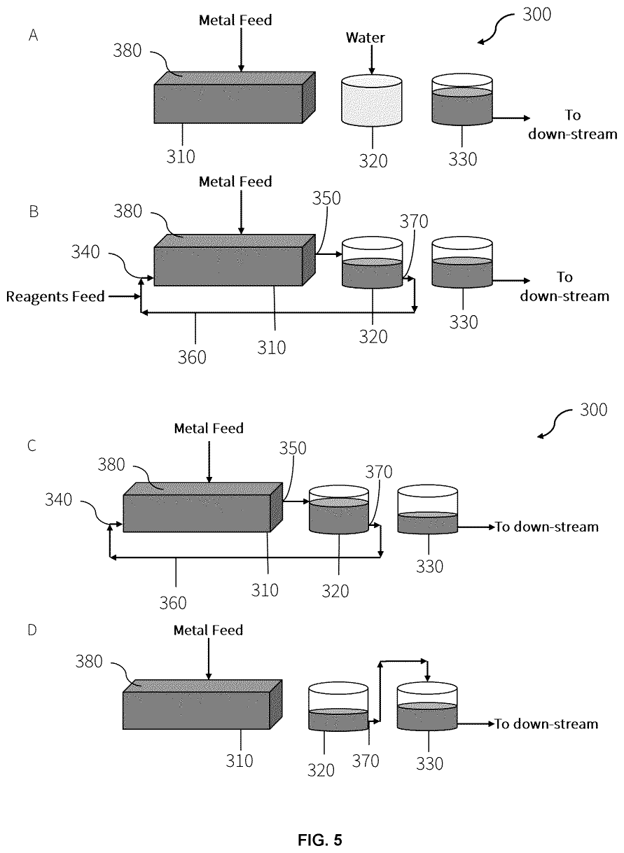

FIG. 5A-D depicts a metal-dissolving system according to embodiments of the present disclosure, comprising a metal-dissolving apparatus. In the embodiments depicted in FIG. 5A-D, the system 300 comprises a metal-dissolving apparatus that comprises a reactor 310. Although reference is made to the reactor 310 with respect to structural features, their locations and their operations, those features, locations, and operations may be similarly applied to any metal-dissolving apparatus in approximately the same ways identified for the reactor 310.

The metal-dissolving system 300 depicted in FIG. 5A-D may be used for implementing a batch process, as described herein. The system 300 may be used for leaching or dissolving metal from a wide range of metal-containing substances (otherwise referred to as “Metal Feed” in FIG. 5A-D). The system 300 comprises a reactor 310, a recirculation tank 320, and a buffer tank 330. The reactor 310 has a metal-dissolving solution inlet 340 at one end, and a metal-dissolving solution outlet at the other end 350. The outlet 350 is connected to the recirculation tank 320. The system 300 also comprises a metal-dissolving solution recirculation loop 360 that takes the solution within the recirculation tank 320 and provides it to the recirculation loop 360 for recirculation back into the reactor 310. The solution within the recirculation tank 320 may begin as water. Once the leaching process commences, however, the solution within the recirculation tank 320 will become semi-loaded (otherwise referred to as semi-pregnant) metal-dissolving solution which is received from the reactor outlet 350. The semi-loaded metal-dissolving solution exits the recirculation tank, enters the recirculation loop 360, and is fed back into the reactor at its inlet 340. The loop 360 is formed by the reactor outlet 350, the recirculation tank 320, the recirculation tank outlet 370 which is connected to the reactor inlet 340, and the reactor inlet 340. The reactor inlet 340 also receives fresh metal-dissolving solution with an acidity that is expected to be higher than the recirculating semi-loaded metal-dissolving solution (otherwise referred to as “Reagents Feed” in FIG. 5A-D). The fresh metal-dissolving solution and the water or the semi-loaded metal-dissolving solution may be combined together prior to providing into the reactor 310 via the inlet 340. Combining the solution from the re-circulation tank/loop with the fresh metal-dissolving solution forms a third solution. By combining those solutions together, the third solution will have a lower acidity and higher flow rate/volume than the fresh metal-dissolving solution, alone. The lower acidity of the third solution helps prevent against excessive dissolution of the metal-containing substances that is close to the inlet 340. The higher volume/flow rate of the third solution helps achieve the desired level of mass transfer for dissolution than the fresh metal-dissolving solution could achieve alone. The entirety of the semi-loaded solution exiting the reactor 310 may be re-circulated back into the reactor 310 via the re-circulation tank 320 and loop 360. The re-circulation process may continue for a number of cycles such that the amount of metal dissolved within the solution in the re-circulation tank 320 increases over time until a target/threshold level of dissolved metal in the solution in the re-circulation tank is reached.

Systems as described herein, such as the system depicted in FIG. 5A-D, may be operated under batch processing conditions.

In an embodiment, the metal-dissolving batch process comprises circulating a metal-dissolving solution through a metal-dissolving apparatus comprising metal-containing substances. The metal-dissolving solution may be circulated through the apparatus with substantially spatial uniformity. The metal-dissolving solution may be circulated through the apparatus with substantially spatial uniformity, under a relatively low hydrostatic load while maintaining substantially uniform metal-dissolving conditions across the length, width and height of the apparatus. The metal-dissolving solution may be provided into the apparatus through a reactant distribution device within the reactor such as a plurality of perforated pipes to more evenly distributed the solution across the apparatus. Other reactant distribution devices are possible, such as manifolds internally to the reactor, injection nozzles penetrating through the floor or side walls of the reactor, etc. The metal-dissolving conditions may comprise pH, leaching-reagent ratios, temperature, dissolved metal concentration, or a combination thereof. The process may comprise dissolving metal from the metal-containing substances into the circulating metal-dissolving solution. The metal-dissolving solution may be circulated into the apparatus at a first location and circulated out of the apparatus as a second location. The first location may be positioned at a lower portion of the apparatus, and the second location may be positioned at an upper portion of the apparatus. The process may further comprise circulating the metal-dissolving solution through a recirculation loop. The recirculation loop may comprise circulating the metal-dissolving solution from the reactor at the second location (with dissolved metal ions therein) to a recirculation tank, and from the recirculation tank to the reactor at the first location. The process may further comprise providing metal-dissolving reagents into the metal-dissolving solution as the solution circulates from the recirculation tank to the reactor at the first location. The process may further comprise circulating the metal-dissolving solution through the recirculation loop, dissolving metal from the metal-containing substances into the metal-dissolving solution thereby incrementally increasing dissolved or leached metal concentration within the metal-dissolving solution, and eventually forming a loaded metal-dissolving solution. The loaded metal-dissolving solution may comprise dissolved or leached metal at a specific, or desired concentration. Once the loaded metal-dissolving solution is formed, the batch process is complete. The process may then comprise flowing the loaded metal-dissolving solution from the recirculation tank to a buffer tank. The process may further comprise flowing the loaded metal-dissolving solution from the buffer tank for further processing downstream.

In an embodiment, the metal-dissolving system 300 depicted in FIG. 5A-D is operated under batch processing conditions, where the metal-dissolving solution may be prepared from reagents that include sulfuric acid and hydrogen peroxide and the process temperatures may be less than, or equal to the temperature at which the decomposition of the hydrogen peroxide substantially occurs (generally taken as less than 85° C.).

The process involves feeding metal-containing substances (Metal Feed) into the reactor 310 through an upper portion 380 of the reactor 310, and filling the recirculation tank 320 with water (FIG. 5A). That water is then circulated through the system 300 using the recirculation loop 360 where fresh metal-dissolving solution is provided into the recirculation loop 360 before the reactor inlet 340, the fresh metal-dissolving solution being formed from fresh acid and optionally oxidant being added into water/semi-loaded metal-dissolving solution from the recirculation tank 320 (FIG. 5B). Over time, as the fresh/semi-loaded metal-dissolving solution circulates through the reactor 310, the concentration of dissolved or leached metal (for example, in the form of metal-ions) in that recirculating solution increases (FIG. 5C). The recirculation loop helps provide the mass transfer for dissolution.

Once the recirculating solution has reached a desired dissolved or leached metal concentration, the loaded metal-dissolving solution is deemed formed. Recirculation and addition of fresh metal-dissolving solution may be stopped (FIG. 5D). By ceasing the addition of fresh metal-dissolving solution, the leaching process occurring within the reactor/apparatus is effectively stopped. The loaded metal-dissolving solution (otherwise referred to as a pregnant leach solution (PLS)) from the recirculation tank 320 may be provided into a buffer tank 330 via the recirculation tank outlet 370. The recirculation tank 320 and the buffer tank 330 may be separated by a valve which prevents the PLS from going from one tank to the other until it is switched. The buffer tank 330 is then disconnected from the recirculation tank 320, and loaded metal-dissolving solution from the buffer tank 330 is sent further downstream for further processing. While the buffer tank loaded metal-dissolving solution is sent downstream, the leaching process may resume (FIG. 5A-D). Resumption of the leaching process may comprise filling the recirculation tank 320 with water (FIG. 5A), then re-commencing providing fresh metal-dissolving solution into the reactor 310 along with the water once there is a sufficient amount of water in the recirculation tank 320.

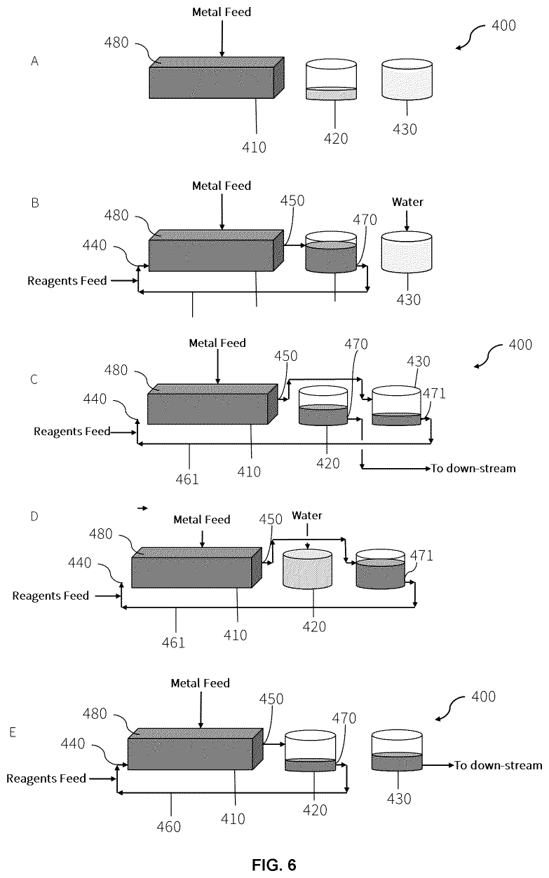

FIG. 6A-E depicts a metal-dissolving system according to embodiments of the present disclosure, comprising a metal-dissolving apparatus as described herein. In the embodiments depicted in FIG. 6A-E, the system 400 comprises a metal-dissolving apparatus 410 that comprises a reactor. Although reference is made to the reactor 410 with respect to structural features, their locations and their operations, those features, locations, and operations may be similarly applied to any other apparatus in approximately the same ways identified for the reactor 410.

The metal-dissolving system 400 depicted in FIG. 6A-E may be used for implementing a batch process, as described herein. The system 400 may be used for leaching or dissolving metal from a wide range of metal-containing substances (otherwise referred to as “Metal Feed” in FIG. 6A-E). The system 400 comprises a reactor 410, a first recirculation tank 420, and a second recirculation tank 430. The reactor 410 has a metal-dissolving solution inlet 440 at one end, and a metal-dissolving solution outlet at the other end 450. The outlet 450 alternates connection between the first recirculation tank 420 and the second recirculation tank 430. The system 400 comprises a first metal-dissolving solution recirculation loop 460 that takes semi-loaded (otherwise referred to as semi-pregnant) metal-dissolving solution from the reactor outlet 450 and feeds it back into the reactor at its inlet 440. The loop 460 is formed by the reactor outlet 450, the recirculation tank 420, the recirculation tank outlet 470 which is connected to the reactor inlet 440, and the reactor inlet 440. The system 400 comprises a second metal-dissolving solution recirculation loop 461 that takes semi-loaded metal-dissolving solution from the reactor outlet 450 and feeds it back into the reactor at its inlet 440. The loop 461 is formed by the reactor outlet 450, the recirculation tank 430, the recirculation tank outlet 471 which is connected to the reactor inlet 440, and the reactor inlet 440. The reactor inlet 440 also receives fresh metal-dissolving solution with an acidity that is expected to be higher than the acidity of the recirculating semi-loaded metal-dissolving solution (otherwise referred to as “Reagents Feed” in FIG. 6A-E). The fresh metal-dissolving solution and the semi-loaded metal-dissolving solution may be combined together prior to providing into the reactor 410 via the inlet 440.

Systems as described herein, such as the system depicted in FIG. 6A-E, may be operated under batch processing conditions. In an embodiment, the metal-dissolving batch process comprises circulating a first metal-dissolving solution through a first recirculation loop comprising a first recirculation tank in fluid communication with a metal-dissolving apparatus comprising metal-containing substances; dissolving metal from the metal-containing substances into the first metal-dissolving solution, and forming a first loaded metal-dissolving solution; and flowing the first loaded metal-dissolving solution downstream from the first recirculation tank. The process further comprises circulating a second metal-dissolving solution through a second recirculation loop comprising a second recirculation tank in fluid communication with the metal-dissolving apparatus comprising metal-containing substances; dissolving metal from the metal-containing substances into the second metal-dissolving solution, and forming a second loaded metal-dissolving solution; and flowing the second loaded metal-dissolving solution downstream from the second recirculation tank. The process further comprises flowing the first loaded metal-dissolving solution downstream while circulating the second metal-dissolving solution through the second recirculation loop. The process further comprises flowing the second loaded metal-dissolving solution downstream while circulating the first metal-dissolving solution through the first recirculation loop.

The first or second metal-dissolving solution may be circulated through the apparatus with substantially spatial uniformity. The first or second metal-dissolving solution may be circulated through the apparatus with substantially spatial uniformity, under a relatively low hydrostatic load while maintaining substantially uniform metal-dissolving conditions across the length, width and height of the apparatus. The first or second metal-dissolving solution may be provided into the apparatus through a plurality of perforated pipes to more evenly distributed the solution across the apparatus. The metal-dissolving conditions may comprise pH, leaching-reagent ratios, temperature, dissolved metal concentration, or a combination thereof.

The process comprises dissolving metal from the metal-containing substances into the circulating first or second metal-dissolving solution. The first or second metal-dissolving solution may be circulated into the apparatus at a first location and circulated out of the apparatus as a second location. The first location may be positioned at a lower portion of the apparatus, and the second location may be positioned at an upper portion of the apparatus. The process comprises circulating the first metal-dissolving solution through a first recirculation loop, and separately circulating the second metal-dissolving solution through a second recirculation loop. The first recirculation loop may comprise circulating the first metal-dissolving solution from the reactor at the second location to a first recirculation tank, and from the first recirculation tank to the reactor at the first location. The second recirculation loop may comprise circulating the second metal-dissolving solution from the reactor at the second location to a second recirculation tank, and from the second recirculation tank to the reactor at the first location. The process may further comprise providing metal-dissolving reagents into the first or second metal-dissolving solution as the solution circulates from the first or second recirculation tank to the reactor at the first location. The process may further comprise circulating the first or second metal-dissolving solution through the first or second recirculation loop, increasing dissolved or leached metal concentration, and forming a first or second loaded metal-dissolving solution. The first or second loaded metal-dissolving solution comprise dissolved or leached metal at a specific, or desired concentration. Once the first or second loaded metal-dissolving solution is formed, the batch process is complete. The process then comprises flowing the first or second loaded metal-dissolving solution from the first or second recirculation tank for further processing downstream. The process comprises flowing the first loaded metal-dissolving solution downstream while circulating the second metal-dissolving solution through the second recirculation loop. The process further comprises flowing the second loaded metal-dissolving solution downstream while circulating the first metal-dissolving solution through the first recirculation loop.

In an embodiment, the metal-dissolving system 400 depicted in FIG. 6A-E is operated under batch processing conditions, where the metal-dissolving solution may be prepared from reagents that include sulfuric acid and hydrogen peroxide and the process temperatures may be less than, or equal to the decomposition temperature of the hydrogen peroxide (generally taken as <85° C.).

The process involves feeding metal-containing substances (Metal Feed) into the reactor 410 through an upper portion 480 of the reactor 410, and filing the first recirculation tank 420 with water (FIG. 6A). That water is then be circulated through the system 400 using the first recirculation loop 460 where fresh metal-dissolving solution is provided into the first recirculation loop 460 before the reactor inlet 440, the fresh metal-dissolving solution being formed from fresh acid and optionally oxidant being added into water/semi-loaded metal-dissolving solution from the first recirculation tank 420. (FIG. 6B). Over time, as the fresh/semi-loaded metal-dissolving solution circulates through the reactor 410, the concentration of dissolved or leached metal (for example, in the form of metal-ions) in that recirculating solution increases. Concurrently, the second recirculation tank 430 may be filled with water.

Once the recirculating solution has reached a desired dissolved or leached metal concentration, a first loaded metal-dissolving solution is deemed to have been formed. Recirculation is then diverted from the first recirculation loop 460 to the second recirculation loop 461, where water from the second recirculation tank 430 is circulated through the system 400 using the second recirculation loop 461 with fresh metal dissolving solution added thereto. Concurrently, the first loaded metal-dissolving solution from the recirculation tank 420 is sent downstream for further processing (FIG. 6C). Once the first recirculation tank 420 is emptied, the entire leaching process repeats itself (FIG. 6A-D). Concurrently, the second loaded metal-dissolving solution from the second recirculation tank 430 is sent downstream for further processing (FIG. 6E).

In both the systems and process of 300 and 400, recirculation of the semi-pregnant leach solution helps dilute the acidity of the fresh leach solution prior to the reactor and also helps with mass transfer to encourage dissolution of the metal through a greater volume of solution passing through the bed of metal in the reactor.

An embodiment of the present disclosure is a metal-dissolving batch process which comprises recirculating all of a semi-pregnant leach solution through a reactor while simultaneously adding fresh leach solution to the reactor to help leach metal from metal-containing substances within the reactor through mixing. The fresh leach solution and the re-circulated semi-pregnant leach solution may be mixed before being provided into the reactor. The recirculation of the semi-pregnant leach solution may be stopped in response to the amount of metal dissolved in the semi-pregnant leach solution reaching a threshold amount so as to form a pregnant leach solution. The pregnant leach solution may be discharged downstream. While the pregnant leach solution is discharged downstream, the addition of fresh leaching solution to the reactor may be stopped.

The pregnant leach solution from a reactor may be mixed/blended with the pregnant leach solution(s) of one or more other reactors to form a final pregnant leach solution that has a desired level of dissolved metals therein. By using multiple batch metal dissolving processes as described herein, and combining the resulting pregnant leach solutions of those individual batch processes in certain amounts, it may be possible to better control the final amount of dissolved metal being sent downstream. Furthermore, this mixing of PLSs may allow the reactors to collectively process a wider variety of metal-containing substances, including without the need to pre-blend the metal-containing substances prior to providing into the reactor(s). The types and amounts of metal in the metal-containing substances that is provided into a reactor may vary significantly over time.

A system and method for controlling the metal-dissolving apparatus as described herein may comprise one or more of the following considerations or limitations. Systems and methods for controlling the apparatuses described in FIGS. 5A-D and 6A-D may comprise one or more of the following considerations and/or limitations, wherein the metal-containing substance comprises nickel and the metal-dissolving solution comprises sulfuric acid and optional oxidant in water.
Nickel concentration may be selected based on the ratio of the flow rates of sulfuric acid and water in the added reagents, with an adjustment for dilution by other reagents.
When an oxidant is used, oxidant flow may be ratioed to acid flow and this ratio may be kept within a relatively tight band of values to avoid too high oxidation potential-which in some systems can lead to metal passivation, and in other systems to losses of oxidant—and too low oxidation potential, which can decrease reaction rate and extent.
The control system may be configured to be a pull or a push system. In the case of a pull system, the desired flow rate of product solution (e.g., nickel loaded metal-dissolving solution) may be drawn from a recirculation tank and pushed forward to the next process stage. In this case, the flow of incoming metal-dissolving solution may be adjusted to control the recirculation tank level. In the case of a push system, the metal-dissolving solution flows may be set to give the required mass flow for metal dissolution at the required concentration, and the level of the recirculation tank may be controlled by a controller to flow out of the system to the next stage of processing.
The rate of metal dissolution may be increased with the solution flow rate through the reactor. The flow through the reactor may be set independently from the reagent flows.
In systems with certain oxidants, the extent of reaction may be generally independent of the exact amount of metal in the dissolver since the oxidants are fast acting. As long as the dissolver can be maintained at approximately 80-100% full of metal, similar dissolving behavior can be expected.

The apparatuses or systems as described herein, for example the apparatuses described in FIGS. 5A-D and 6A-D, may comprise instrumentation to measure a combination of temperature, metal concentration, residual acid, and residual oxidant (if present) at the solution outlet of the reactor. Spectrometric measurements, colourometric measurements, solution density, pH measurements, or ORP measurements, for example, may be proxies for determining metal concentration, acidity and residual oxidant in certain systems. The apparatuses or systems described herein, for example the apparatuses described in FIGS. 5A-D and 6A-D, may comprise instrumentation to help detect impurities, including impurities that may be detrimental to a downstream process. In an embodiment, the instrumentation for helping detect impurities may be configured to take measurements of the solution leaving the metal-dissolving apparatus, or a recirculation tank. The impurities measurements may be used to control the metal-containing substance being fed into the metal-dissolving apparatus. That control may include slowing or stopping specific metal-containing substances from being fed into the apparatus in response to a threshold impurities level being detected by the instrumentation.

Use of such instrumentation and corresponding readings may enable controlling the herein described apparatuses or systems to affect discharge solution composition, and/or to help avoid a large recirculation tank. An example is outlined in the table below of a method (including selected parameters) for controlling herein described apparatuses/reactors using said aforementioned readings according to a “pull” control strategy. A similar method exists for a “push” based control strategy.

| | Acidity | Oxidant | Nickel | |
|---|---|---|---|---|
| Scenario | level | level | concentration | Action |
| 1 | Above | low | low | Increase oxidant/acid reagent ratio |
| | target | | | |
| 2 | Above | high | low | Increase flow through reactor |
| | target | | | If flow is at maximum, then decrease |
| | | | | bleed solution pull flow |
| | | | | Note that this situation could also |
| | | | | occur if oxidant has been dosed too |
| | | | | fast (i.e. outside the normal reagent |
| | | | | control range and the metal has |
| | | | | passivated (which happens with |
| | | | | nickel, particularly). In that case |
| | | | | different steps are needed outside |
| | | | | the scope of this normal control |
| | | | | strategy. |
| 3 | Above | low | high | Increase oxidant/acid ratio with |
| | target | | | allowable range. Adjust acid/water |
| | | | | ratio down within allowable range |
| 4 | Above | high | high | Decrease acid/water ratio |
| | target | | | |
| 5 | On target | low | low | As 1 and increase acid/water ratio |
| 6 | On target | High | low | As 2 but also increase oxidant/acid |
| | | | | ratio. |
| 7 | On target | low | high | Decrease acid/water ratio and |
| | | | | increase oxidant/acid ratio |

The above control method is representative only. With the instrumentation scheme, an automated control scheme may be enacted to keep the composition of the stream from this system to the next process stage within tight bounds.

Metallic copper may be formed in a reactor. It may be formed as cemented copper on nickel powder, for example. The formation of metallic copper in the reactor is undesirable. High levels of pH (insufficient acid) and/or low levels of peroxide in the reactor or at certain locations of the reactor can cause metallic copper to form.

In conventional column reactors, for example, metallic copper has a higher likelihood of forming at or near the solution discharge area and/or upper areas of the column (in the case of a column operating in counter-current mode, for example) where the pH is the highest (lowest acidity) and/or peroxide is the lowest. This is due to the pH/peroxide vertical gradient across the reactor. As the metal-dissolving solution having high acidity and/or high peroxide levels passes through the column reactor to the discharge box/upper area, the acidity of the solution and/or the amount of peroxide in the solution decreases as it is consumed by dissolving the metal-containing substances therebetween. The taller the column, the greater the pH/peroxide gradient across the reactor and the greater the risk of metallic copper formation.

In an embodiment, the reactor(s) and/or apparatus having a height that is less than its length may result in more uniform process conditions throughout the reactor(s)/apparatus, such as pH levels and peroxide levels, to help inhibit the formation of metallic copper. As compared to a conventional column reactor, the lower height of the reactor of the present disclosure may result in elevated oxidizer concentrations exiting the reactor (such as at the top of the reactor) such that the metal within the reactor is exposed to a more uniform oxidizer concentration profile over the entire height of the reactor. This uniform exposure reduces the likelihood of there being insufficient oxidizer levels at certain areas of the reactor that would allow for the formation of metallic copper from the leaching solution in those areas. In an embodiment of the present disclosure, to help inhibit metallic cementation of copper, the operating conditions of targeted areas/zones (such as the upper area/zone of the reactor) that may be prone to metallic copper formation are manipulated to cause solubilization of nickel powders (upon which copper may cement) and/or to create other conditions unfavorable for copper cementation. The solution containing copper may then be treated, including in a secondary reactor (such as box reactor in accordance with the present disclosure that may be smaller than the main reactor) dedicated to copper removal by creating a favorable condition to form metallic copper and separate from the solution.

In another embodiment, the copper in solution emerging from the reactor is separated in a downstream process such as ion exchange and/or neutralization, and/or any other separation method.

In an embodiment, the oxidative reduction potential solution and/or pH may be selected to help inhibit copper cementation in the reactor. The copper may then be captured downstream of the reactor. The copper may be captured downstream by one or more reactors.

In an embodiment, the formation of metallic copper in a reactor may be inhibited by intermittently or continuously changing the operating conditions of the reactor. In an embodiment of changing the operating conditions, the pH levels in the reactor may be lowered where solution is provided into the reactor. A supplemental solution with a lower pH may be provided into the reactor at any portion of the reactor along the path of solution through the reactor. The supplemental solution may comprise an oxidizer. These operating conditions may be changed in a specific area of the reactor such as area where solution is discharged from the reactor which may be the upper zone or the reactor operating in counter-current mode.

What is claimed is:

1. A metal-dissolving apparatus, comprising:
a reactor;
a metal inlet at a first location for providing into the reactor a metal-containing substance;
a solution inlet at a second location for providing into the reactor a metal-dissolving solution;
a solution outlet at a third location for discharging from the reactor the metal-dissolving solution; and
a ventilation port at a fourth location;
wherein the apparatus comprises a length and a height, the height being less than the length.

2. The metal-dissolving apparatus of claim 1, wherein the apparatus is the reactor.

3. The metal-dissolving apparatus of claim 1, wherein the apparatus comprises a plurality of reactors.

4. The metal-dissolving apparatus of claim 3, wherein each of the plurality of reactors has a length and a height,
the height being less than the length, or
the height being greater than the length.

5. The metal-dissolving apparatus of any one of claims 1 to 4, further comprising a divider defining a plurality of reactors within the apparatus.

6. The metal-dissolving apparatus of any one of claims 1 to 5, further comprising a reactant distribution device disposed within the apparatus for receiving the solution and distributing the solution with substantially spatial uniformity throughout the reactor.

7. The apparatus of claim 1, further comprising a delivery system coupled to the apparatus for providing the metal-containing substance to the metal inlet.

8. The apparatus of any one of claim 1 or 7, wherein the apparatus comprises a height to width ratio of less than one.

9. The apparatus of any one of claim 1 or 8, wherein the apparatus is self-supporting.

10. The apparatus of any one of claims 1 to 9, wherein the reactor is configured to fit within a standard shipping container, such as a shipping container having dimensions of about 4×4×12 m.

11. The apparatus of any one of claims 1 to 10, wherein the reactor is substantially rectangular in shape.

12. The apparatus of any one of claims 1 to 11, wherein the reactor is modular.

13. The apparatus of any one of claims 1 to 6, wherein the metal inlet is at a first location along an upper portion of the reactor.

14. The apparatus of any one of claims 1 to 13, wherein:
the solution inlet is at a second location along the height and length of the reactor, and optionally extends along the length of the reactor; or
the solution inlet is at a second location along the height and width of the reactor, and optionally extends along the width of the reactor.

15. The apparatus of any one of claims 1 to 14, wherein:
the solution outlet is at a third location along the height and length of the reactor, and optionally extends along the length of the reactor; or
the solution outlet is at a third location along the height and width of the reactor, and optionally extends along the width of the reactor.

16. The apparatus of any one of claims 1 to 15 wherein, when along the length of the reactor, the solution inlet is within a lower portion of the reactor and the solution outlet is within an upper portion of the reactor for providing flow of solution countercurrent to flow of metal-containing substance.

17. The apparatus of any one of claims 1 to 16 wherein, when along the length of the reactor, the solution inlet is within an upper portion of the reactor and the solution outlet is within a lower portion of the reactor for providing flow of solution co-current to flow of metal-containing substance.

18. The apparatus of any one of claims 1 to 17 wherein, when along the width of the reactor, the solution inlet is at one end the reactor and the solution outlet is at an opposing end of the reactor for providing flow of solution crosscurrent to flow of metal-containing substance.

19. The apparatus of any one of claims 1 to 18, wherein the solution inlet comprises a series of inlets extending along an outside length of the reactor coupled to a series of perforated pipes extending across an inside width of the reactor for distributing the metal-leaching solution with substantially spatial uniformity throughout the reactor.

20. The apparatus of any one of claims 1 to 19, wherein the solution inlet comprises a tapered manifold.

21. The apparatus of any one of claims 1 to 20, wherein the ventilation system comprises a gas outlet for providing gas flow out of the reactor, optionally further comprising a gas inlet for providing gas flow into the reactor and optionally further comprising a gas-capturing system.

22. The apparatus of any one of claims 6 to 21, wherein the reactant distribution device comprises a perforated pipe disposed within the apparatus for receiving the solution from the inlet and distributing the solution with substantially spatial uniformity throughout the reactor.

23. A metal-dissolving process, comprising
providing with substantially spatial uniformity a metal-dissolving solution into a first location of a metal-dissolving apparatus comprising metal-containing substances;
flowing the metal-dissolving solution through the apparatus under a relatively low hydrostatic load while maintaining substantially uniform metal-dissolving conditions across the length, width and height of the apparatus;
dissolving metal from the metal-containing substances into the metal-dissolving solution; and
discharging the metal-dissolving solution from a second location of the apparatus.

24. The metal-dissolving process of claim 24, wherein the first location is a lower portion of the apparatus, and the second location is an upper portion of the apparatus.

25. The process of claim 23, wherein the process is a continuous process or a batch process.

26. The process of any one of claims 23 to 25, wherein the solution is provided into the apparatus through a plurality of perforated pipes to more evenly distributed the solution across the apparatus.

27. The process of any one of claims 23 to 26, wherein the metal-dissolving solution is re-circulated or recycled, or a portion of the solution is recirculated or recycled

28. The process of any one of claims 23 to 27, wherein the metal-dissolving conditions comprise pH, leaching-reagent ratios, temperature, dissolved metal concentration, or a combination thereof.

29. The process of any one of claims 23 to 28, wherein the apparatus comprises a rectangular reactor having a shorter height relative to length.

30. The process of any one of claims 23 to 29, wherein the solution is provided into a reactant distribution device within the apparatus to more evenly distribute the solution across the apparatus.

31. Use of a metal-dissolving apparatus having a shorter height relative to length for dissolving metal from metal-containing substances.

32. A metal-dissolving process, comprising
providing metal-containing substances into a reactor;
receiving and mixing a fresh metal-dissolving solution and a second solution to form a third solution being a metal-dissolving solution, the second solution having an amount of dissolved metals therein that is less than a threshold amount;
providing the third solution into the reactor;
flowing the third solution through the reactor to dissolve metal from the metal-containing substances to form a semi-loaded solution;
providing all of the semi-loaded solution back into the reactor as the second solution of the third solution.

33. The metal-dissolving process of claim 32, wherein the second solution is initially water.

34. The metal-dissolving process of any one of claims 32 and 33, further comprising providing water into a recirculation tank, and providing the second solution from the re-circulation tank.

35. The metal-dissolving process of any one of claims 32 to 34, further comprising re-circulating through the reactor all of the semi-loaded solution as the second solution of the third solution until the semi-loaded solution contains the target threshold amount of dissolved metals therein to form a pregnant leach solution.

36. The metal-dissolving process of any one of claims 32 to 35, further comprising ceasing receiving the fresh metal dissolving solution in response to the semi-loaded solution forming the pregnant leach solution.

37. The metal-dissolving process of any one of claims 32 to 36, further comprising providing the pregnant leach solution downstream.

38. The metal-dissolving process of claim 37, wherein providing the pregnant leach solution downstream comprises providing the pregnant leach solution to a buffer tank.

39. The metal-dissolving process of claim 37, further comprising receiving water from a second recirculation tank after all of the pregnant leach solution has been provided downstream.

40. The metal-dissolving process of any one of claims 32 to 39, further comprising mixing the pregnant leach solution of the process with pregnant leach solution(s) of one or more other metal-dissolving processes to form a fourth solution with a desired level of dissolved metal therein.

41. A metal-dissolving apparatus, comprising:
a reactor;
a metal inlet at a first location in the reactor for receiving a metal-containing substance;
a solution inlet at a second location in the reactor for receiving a metal-dissolving solution;
a solution outlet at a third location in the reactor for discharging from the reactor the metal-dissolving solution with dissolved metal therein; and
a re-circulation loop comprising a re-circulation tank connecting the solution outlet to the solution inlet for providing all of the metal dissolving solution from the solution outlet to the solution inlet.

42. The metal-dissolving apparatus of claim 41, further comprising a valve for providing all of the contents of the re-circulation tank back to the solution inlet.

43. The metal-dissolving apparatus of claim 42, further comprising a buffer tank connected to the re-circulation tank via the valve, wherein the valve inhibits the metal-dissolving solution from going from the re-circulation tank to the buffer tank until the metal-dissolving solution contains a threshold amount of dissolver metal therein.

44. The metal-dissolving apparatus of any one of claims 1 to 29, further comprising a copper-handling reactor in fluid communication with the one or more reactors for receiving the pregnant leach solution from the reactors, the copper-handling reactor for cementing the copper within the reactor from the pregnant leach solution.

45. The metal-dissolving process of any one of claims 32 to 40, further comprising inhibiting the formation of metallic copper in an area of the one or more reactors by changing the operating conditions of the reactor(s).

46. The metal-dissolving process of claim 45, wherein changing the operating conditions comprises lowering the pH level in one or more of the reactors or specific area(s) thereof.

47. The metal-dissolving process of claim 45, wherein changing the operating conditions comprises causing a different oxidative potential in one or more of the reactors of specific area(s) thereof.

48. The metal-dissolving process of claim 46, wherein lowering the pH comprises providing additional acid into the one or more reactors.

49. The metal-dissolving process of claim 47, wherein causing the different oxidative potential comprises providing an additional oxidizer into the one or more reactors.

50. The metal-dissolving process of claim 48 or 49, wherein the additional acid or the additional oxidizer is provided into the one or more reactors via the third solution.

51. The metal-dissolving process of claim 48 or 49, wherein the additional acid or the additional oxidizer is provided into the one or more reactors as a supplemental solution at a supplemental location different than the location at which the third solution is provided into the reactor(s).

52. The metal-dissolving process of claim 51, wherein the supplemental solution is formed by receiving semi-loaded solution from the one or more reactors and providing the additional acid and/or the additional oxidizer thereto.

53. The metal-dissolving process of claim 52, wherein the semi-loaded solution is received from an intermediary withdrawal location of the one or more reactors which may be a location that is between the location for providing the third solution into the reactor(s) and the location for withdrawing the semi-loaded solution or the pregnant leach solution from the reactor(s).

54. The metal-dissolving process of claim 51 or 52, wherein the supplemental solution is provided at a location that is proximate to the location of the reactor(s) where the semi-loaded solution or the pregnant leach solution is withdrawn from the reactor(s).

55. The metal-dissolving process of claim 51 or 52, wherein the supplemental location is the upper zone(s) of the reactor(s).

56. The metal-dissolving process of any one of claims 32 to 55, further comprising capturing and/or separating copper from the pregnant leach solution.

57. The metal-dissolving process of claim 56, further comprising receiving the pregnant leach solution in a downstream reactor and cementing metallic copper from the pregnant leach solution in the downstream reactor.

58. The metal-dissolving process of claim 57, further comprising separating the copper from the pregnant leach solution downstream of the reactor(s) using ion exchange, neutralization, or another separation method.
